(19) United States
(12) Patent Application Publication
(10) Pub. No.: US 2012/0057024 A1
(43) Pub. Date: Mar. 8, 2012

(54) SYSTEM AND METHOD FOR MONITORING COMPONENT WEAR

(75) Inventors: Subhash Nemani, Hyderabad (IN); Ravi Kanth S. Thatikonda, Hyderabad (IN)

(73) Assignee: GENERAL ELECTRIC COMPANY, Schenectady, NY (US)

(21) Appl. No.: 12/876,430

(22) Filed: Sep. 7, 2010

(51) Int. Cl. H04N 7/18; H04N 5/77

(52) U.S. Cl. 348/143; 386/224; 348/E07.085; 386/E05.069

(57) ABSTRACT

A system for monitoring a moving component includes an input device directed at the moving component. The input device generates a signal reflective of a position of the moving component. A processor in communication with the input device receives the signal from the input device and generates a graph reflective of the position of the moving component. A method for monitoring a moving component includes recording the moving component as it moves and graphing locations of the moving component.

### FIELD OF THE INVENTION

The present invention generally involves a system and method for monitoring wear in a component. For example, particular embodiments of the present invention may be used to detect, analyze, and/or predict out of round conditions, vibrations, maintenance and/or repair intervals, and/or operational changes in moving components.

### BACKGROUND OF THE INVENTION

Gas turbines, pumps, fans, generators, motors, and other forms of commercial equipment frequently include components that move inside or proximate to stationary components. The clearance between the moving components and stationary components is an important design consideration that balances mechanical efficiency and performance with manufacturing and maintenance costs. Specifically, a reduced clearance between the moving and stationary components generally improves efficiency and performance of equipment. However, a reduced clearance may also increase the manufacturing costs to achieve the reduced clearance and may also increase maintenance costs attributed to increased rubbing, friction, or other impact between the moving and stationary components as a result of the reduced clearance. The increased manufacturing and maintenance costs may be a particular concern in commercial equipment having a relatively large cost, large mass, or in which the moving components move or rotate at relatively high speeds. Where possible, the moving components may be coupled to the stationary components using bearings, universal joints, lubricants, and other mechanical devices suitable for lubricating and/or reducing friction between the moving and stationary components. For example, a journal bearing may be installed around a rotating component to couple the rotating component to a stationary component. The journal bearing remains stationary, and a combination of bearings and/or lubricants inside the journal bearing allow the rotating component to rotate freely with respect to the stationary component.

Various manufacturing and operational concerns may produce eccentricities, out of round conditions, or misalignment between the moving and stationary components that may result in excessive vibration, friction, wear, or other undesirable interactions between the moving and stationary components. For example, tolerances in the manufacture of rotating and stationary components may result in slight eccentricities between the rotating and stationary components. Although static adjustments during assembly may decrease these eccentricities, normal wear and tear incident to operation of the commercial equipment may produce additional eccentricities between the rotating and stationary components. For example, bearing oil lift, thermal growth of the bearing structures, vibrations of associated equipment, uneven thermal expansion, slippage, and gravity sag are a few examples of normal wear and tear incident to operations that may increase existing eccentricities or add new eccentricities between the rotating and stationary components. Eventually, the number and magnitude of eccentricities between the rotating and stationary components will result in unacceptable vibration, friction, wear, or other undesirable interactions between the rotating and stationary components if not continuously monitored and corrected.

Various systems and methods are known in the art for detecting and monitoring wear between moving and stationary components. For example, excessive wear between moving and stationary components may produce increased vibrations and/or temperatures. Accelerometers or strain gauges may thus be used to measure vibration levels to identify or predict impending component failure. However, the accelerometers and strain gauges typically must be in physical contact with the moving and/or stationary components, and this physical contact is not always possible. In addition, other associated components may cause vibrations in the moving and/or stationary components which reduce the sensitivity and/or accuracy of the accelerometers or strain gauges.

Fiber-optic, eddy current, and capacitive systems may also be used to detect and monitor vibrations and/or temperatures in moving components. Although these systems do not require direct physical contact with the moving components, these systems typically require close proximity, on the order of millimeters or mills, to the moving or stationary components to function effectively. In addition, temperature is a slower and less reliable indicator of component wear, and the systems may not be able to detect the slight temperature changes before damage occurs. Laser-based systems do not typically require such a close proximity and may be more sensitive to temperature changes; however, laser-based systems are substantially more expensive and may therefore be cost prohibitive.

Although each of these systems and methods have varying degrees of effectiveness, each system and method also includes various disadvantages or limitations. Therefore, additional improvements in systems and methods to detect, analyze, and/or predict changes in the alignment, clearances, eccentricities, or out of roundness between moving and stationary components would be useful.

### BRIEF DESCRIPTION OF THE INVENTION

Aspects and advantages of the invention are set forth below in the following description, or may be obvious from the description, or may be learned through practice of the invention.

One embodiment of the present invention is a system for monitoring a moving component. The system includes an input device directed at the moving component, and the input device generates a signal reflective of a position of the moving component. A processor is in communication with the input device, and the processor receives the signal from the input device and converts the signal to an ordered pair in a Cartesian coordinate system.

Another embodiment of the present invention is a system for monitoring a moving component that includes an input device directed at the moving component. The input device generates a signal reflective of a position of the moving component. A processor in communication with the input device receives the signal from the input device and generates a graph reflective of the position of the moving component.

The present invention may also include a method for monitoring a moving component. The method includes recording the moving component as it moves and graphing locations of the moving component.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a simplified plan drawing of a device under test;

FIG. 2 is a simplified diagram of a system according to one embodiment of the present invention; and

FIG. 3 shows an exemplary graph produced by the system shown in FIG. 2.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

Embodiments of the present invention provide a system and method that may be used to monitor wear in a moving component. Embodiments within the scope of the present invention may record movement of some or all of the moving component. The movement of the component may be caused by gradual wear, improper assembly, component damage, or virtually any event requiring operator intervention. The recorded movement of the component may be plotted or graphed, for example in a Cartesian coordinate system. The plot or graph may then be compared to a predetermined curve, and, if the plot or graphed exceeds the predetermined curve, then corrective action may be implemented. The corrective action may consist of any action to address the movement of the component. For example, the corrective action may include actuating warning lights, adjusting maintenance and/or inspection schedules, adjusting oil lift pressure, starting additional pumps to increase the pressure or supply of lubricating fluid, and/or immediately stopping the rotating component.

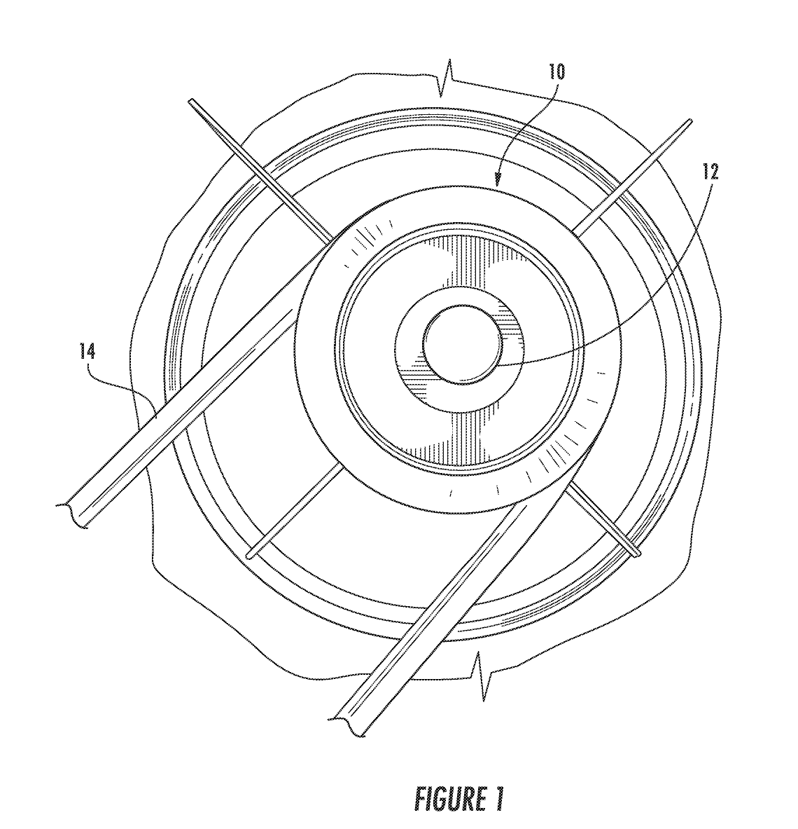

FIG. 1 provides a simplified drawing of an exemplary device under test to be monitored by any embodiment of the present invention. The present invention is not limited to any particular device under test, and the device under test may comprise any component that moves. For example, a moving component 10 may be the rotor in a generator, motor, turbine, or compressor, or virtually any component in any machine that moves. In FIG. 1, the moving component 10 is illustrated as a shaft 12 driven by a pulley 14, such as may exist in a fan, generator, motor, compressor, or other machine. One of ordinary skill in the art will readily appreciate that the present invention is not limited to any particular moving component, and alternate embodiments of the present invention may be used with virtually any component that moves or rotates in any direction.

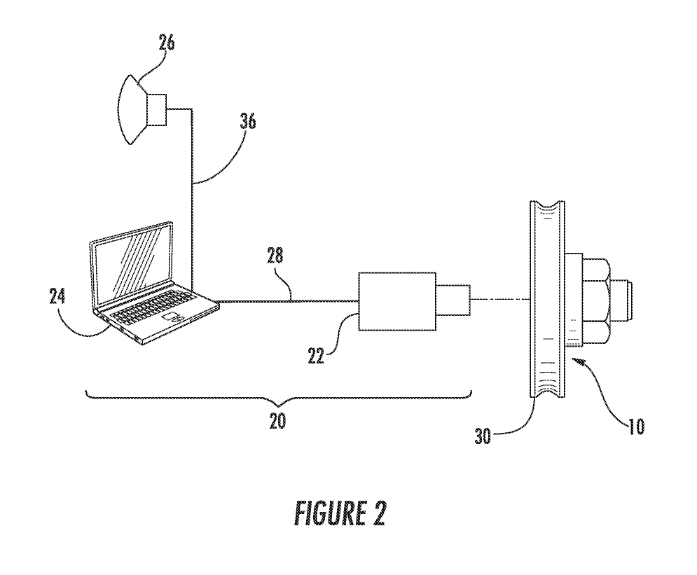

FIG. 2 provides a simplified diagram of a system 20 for monitoring the moving component 10 according to one embodiment of the present invention. As shown in FIG. 2, the system 20 generally includes an input device 22, a processor 24, and an output device 26. The input device 22 may comprise any sensor known in the art that is capable of monitoring and/or recording the moving component 10 as it moves or rotates. For example, the input device 22 may be a WebCam, an analog or digital camera, an analog or digital video camera or recorder, an infrared sensor, or similar device. The input device 22 may be positioned at any suitable distance from the moving component 10, and the position of the input device 22 may be adjustable to accommodate ambient or environmental changes, such as lighting, shadows, or other obstructions between the input device 22 and the moving component 10, so that the input device 22 may view all or only a portion of the moving component 10. For example, as shown in FIG. 2, the input device 22 may be directed at the moving component 10 at a suitable distance so that the input device 22 can monitor and/or record an entire surface of the moving component 22. In alternate embodiments, the input device 22 may be located closer to the moving component 10 and therefore capable of monitoring and/or recording only a portion of the moving component 10.

The input device 22 monitors and/or records the moving component 10 as it moves or rotates. The input device 22 then generates a signal 28 reflective of each recorded position of the moving component 10. The signal 28 may be an analog or digital signal. For example, a camera used as the input device 22 may be programmed to photograph the moving component 10 at specific intervals. The specific interval selected will depend on a number of operational factors, such as, for example, the linear or rotational speed of the moving component 10, the desired resolution, the interval between planned maintenance or repairs, and/or the specific repair history for the particular moving component 10. After each photograph or frame, the camera may generate and transmit to the processor 24 the signal 28 reflective of each recorded position of the moving component 10. For example, the signal 28 generated and transmitted by the camera to the processor 24 may comprise a still photograph of the moving component 10 at each position. A WebCam, video camera or recorder, or infrared sensor may similarly be programmed to record continuous movement of the moving component 10 and stream the continuously recorded movement to the processor 24 as the signal 28 reflective of the continuous movement of the moving component 10.

The processor 24 is in communication with the input device 22 to receive the signal 28 generated by the input device 22. Algorithms programmed into the processor 24 may convert the signal 28 from the input device 22 into a digital signal, if it is not already a digital signal, that can be plotted, graphed, or otherwise converted to mathematical equations to form a curve 32 showing the movement of the moving component 10. For example, the processor 24 may use image recognition software to detect an outer perimeter 30 of the moving component 10 in the still photographs or streaming video transmitted by the input device 22. The processor 24 may then assign an ordered pair in a Cartesian coordinate system to discrete points along the outer perimeter 30 of the moving component 10. The processor 24 may then plot or graph the collection of ordered pairs for all of the discrete points along the outer perimeter 30 of the moving component 10. In this manner, the plot or graph 32 of the outer perimeter 30 of the moving component 10 may be used to visually reflect movement of the moving component 10.

As described herein, the technical effect of the processor 24 is to control the timing and operation of the input device 22 and the receive and process the signal 28 generated by the input device 22. The processor 24 may be a stand alone component or a sub-component included in any computer system known in the art, such as a laptop, a personal computer, a mini computer, a mainframe computer, or industrial controllers, microcontrollers, or embedded systems. The various processor 24 and computer systems discussed herein are not limited to any particular hardware architecture or configuration. Embodiments of the systems and methods set forth herein may be implemented by one or more general-purpose or customized processors 24 adapted in any suitable manner to provide the desired functionality. The processor 24 may be adapted to provide additional functionality, either complementary or unrelated to the present subject matter. For instance, one or more processors 24 may be adapted to provide the described functionality by accessing software instructions rendered in a computer-readable form. When software is used, any suitable programming, scripting, or other type of language or combinations of languages may be used to implement the teachings contained herein. However, software need not be used exclusively, or at all. For example, as will be understood by those of ordinary skill in the art without required additional detailed discussion, some systems and methods set the forth and disclosed herein may also be implemented by hard-wired logic or other circuitry, including, but not limited to, application-specific circuits. Of course, various combinations of computer-executed software and hard-wired logic or other circuitry may be suitable as well.

It is to be understood by those of ordinary skill in the art that the systems and methods disclosed herein may be executed by one or more suitable processors 24 that render the system operative to implement such methods. As noted above, such systems may access one or more computer-readable media that embody computer-readable instructions which, when executed by at least one processor 24, cause the at least one processor 24 to implement one or more of the methods of the present subject matter. Any suitable computer-readable medium or media may be used to implement or practice the presently-disclosed subject matter, including, but not limited to, diskettes, drives, and other magnetic-based storage media, optical storage media, including disks (including CD-ROMS, DVD-ROMS, and variants thereof), flash memory, RAM, ROM, and other solid-state memory devices, and the like.

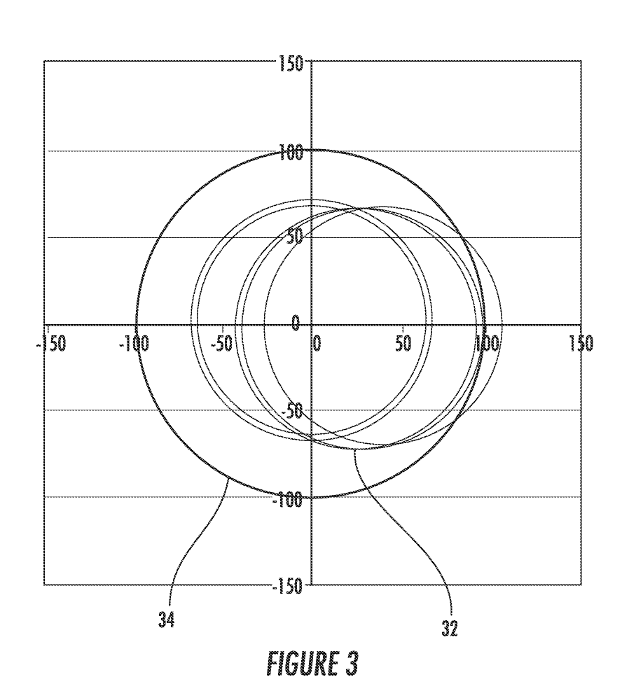

FIG. 3 provides an exemplary plot or graph 32 produced by the system 20 to illustrate the movement of the moving component 10. As shown in FIG. 3, the processor 24 has converted the signal 28 from the input device 22 into the graph 32 that shows the movement of the outer perimeter 30 of the moving component 10. Since the moving component 10 rotates, the graph 32 appears as a series of circles that have moved over time to reflect the corresponding movement of the outer perimeter 30 of the moving component 10 that may be caused by vibration or eccentricities in the shaft 12, a lack of lubrication, or some other result of wear.

The thicker circle shown in FIG. 3 represents a predetermined limit 34 that may be programmed into the processor 24. The predetermined limit 34 may graphically represent the maximum allowed movement of the moving component 10 before initiating some corrective action. For example, the predetermined limit 34 may represent the amount of movement that results in the moving component 10 contacting or rubbing against an adjacent stationary component. As another example, the predetermined limit 34 may represent the amount of movement that produces excessive vibration, temperature, etc. in the commercial equipment.

The processor 24 may thus be programmed to compare the graph 32 of the movement of the moving component 10 with the predetermined limit 34. Everywhere the graph 32 intersects or crosses through the predetermined limit 34 represents a point of concern. The processor 24 may be further programmed to initiate action based on the graph 32 of the movement of the moving component 10. The actual action initiated by the processor 24 will, of course, depend on various design considerations, such as the particular component involved and the particular predetermined limit 34 programmed into the processor 24. For example, the predetermined limit 34 may simply represent the maximum allowed movement of the moving component 10 between periodic inspections. In that case, when the processor 24 detects that the graph 32 of movement of the moving component 10 intersects or crosses the predetermined limit 34, the processor 24 may simply generate an output signal 36 to the output device 26. The output signal 36 may actuate a warning light that alerts an operator to inspect the moving component 10. In alternate embodiments, the output signal 36 may include repair or maintenance scheduling information that allows the operator to adjust previously scheduled repair or maintenance. The adjusted repair and/or maintenance schedule improves the reliability and operation of the particular commercial equipment, resulting in a more accurate, and possibly extended, useful life for the particular commercial equipment. By way of further example, the predetermined limit 34 may indicate the point at which the moving component 10 rubs against or impacts another adjacent component. In that case, when the processor 24 detects that the graph 32 of movement of the moving component 10 intersects or crosses the predetermined limit 34, the processor 24 may initiate more immediate and decisive actions. For example, the output signal 36 generated by the processor 24 may trip or automatically shut down the commercial equipment to prevent more extensive or catastrophic damage to the commercial equipment or nearby personnel. In this manner, embodiments of the system 20 within the scope of the present invention may not only detect excessive movement of the moving component 10, but they may also pinpoint a precise location of concern and initiate appropriate corrective action to minimize or prevent any damage caused by excessive movement of the moving component 10.

The output device 26 is in communication with the processor 24 and may comprise any device known in the art for recording and/or conveying information. For example, the output device 26 may include an alarm circuit, a printer, a recording system, or an announcing circuit. The output device 26 may convey various information to the operators relevant to the predetermined limit 34. For example, the output device 26 may identify the specific predetermined limit 34 which was exceeded, the location on the moving equipment 10 that exceeded the predetermined limit, and/or a list of options available to the operator to correct the specific condition.

Various embodiments of the system 20 described and illustrated with respect to FIGS. 1, 2, and 3 may provide several benefits in identifying and responding to excessive movement by the moving component 10. For example, the graph 32 showing movement of the moving component 10 provides a historical record that may be manually reviewed and analyzed to determine trends and/or predict when the moving component 10 will move beyond the predetermined limit 34. As a result, preventive or corrective maintenance schedules may be adjusted to perform the preventive or corrective maintenance before the moving component 10 moves beyond the predetermined limit 34, thus preventing and/or reducing unplanned outages. As another example, the moving component 10 may only move beyond the predetermined limit briefly and at sporadic intervals, making manual detection and precise location of the excessive movement difficult. However, the processor 24 programmed according to the embodiments of the present invention may readily, instantaneously, and reliably identify not only the brief instances in which the moving component 10 moves beyond the predetermined limit 34, but also the precise location on the moving component 10 that exceeded the predetermined limit.

One of ordinary skill in the art will readily appreciate that the system 20 previously described with respect to FIGS. 1, 2, and 3 provides a method for monitoring the moving component 10. Specifically, the method may include recording the moving component 10 as it moves or rotates and graphing locations of the moving component 10. The method may further include recording the moving component 10 as it moves or rotates using a video camera and/or converting the locations of the moving component 10 to a digital signal. In alternate embodiments, the method may include converting the locations of the moving component 10 to an ordered pair in a Cartesian coordinate system and/or comparing the locations of the moving component 10 to the predetermined limit 34. Still further embodiments may include generating the output signal 36 reflective of the locations of the moving component 10, and particular output signals 36 may include at least one of repair and/or maintenance scheduling information.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other and examples are intended to be within the scope of the claims if they include structural elements that do not differ from the literal language of the claims, or if they include equivalent structural elements with insubstantial differences from the literal languages of the claims.

What is claimed is:

1. A system for monitoring a moving component comprising:
a. an input device directed at the moving component, wherein said input device generates a signal reflective of a position of the moving component;
b. a processor in communication with said input device, wherein said processor receives said signal from said input device and converts said signal to an ordered pair in a Cartesian coordinate system.

2. The system as in claim 1, wherein said input device is a digital video recorder.

3. The system as in claim 1, wherein said signal is a digital signal.

4. The system as in claim 1, wherein said processor converts said signal to a digital signal.

5. The system as in claim 1, wherein said processor compares said ordered pair to a predetermined limit.

6. The system as in claim 1, further comprising an output device in communication with said processor.

7. The system as in claim 6, wherein said processor generates an output signal to said output device, wherein said output signal includes at least one of repair or maintenance scheduling information.

8. A system for monitoring a moving component comprising:
a. an input device directed at the moving component, wherein said input device generates a signal reflective of a position of the moving component;
b. a processor in communication with said input device, wherein said processor receives said signal from said input device and generates a graph reflective of the position of the moving component.

9. The system as in claim 8, wherein said input device is a digital video recorder.

10. The system as in claim 8, wherein said processor converts said signal to an ordered pair in a Cartesian coordinate system.

11. The system as in claim 8, wherein said processor compares said graph to a predetermined limit.

12. The system as in claim 8, further comprising an output device in communication with said processor.

13. The system as in claim 12, wherein said processor generates an output signal to said output device, wherein said output signal includes at least one of repair or maintenance scheduling information.

14. A method for monitoring a moving component comprising:
a. recording the moving component as it moves; and
b. graphing locations of the moving component.

15. The method as in claim 14, further comprising recording the moving component as it moves using a video camera.

16. The method as in claim 14, further comprising converting the locations of the moving component to a digital signal.

17. The method as in claim 14, further comprising converting the locations of the moving component to an ordered pair in a Cartesian coordinate system.

18. The method as in claim 14, further comprising comparing the locations of the moving component to a predetermined limit.

19. The method as in claim 14, further comprising generating an output signal reflective of the locations of the moving component.

20. The method as in claim 14, further comprising generating an output signal that includes at least one of repair or maintenance scheduling information.
